(19) United States
(12) Patent Application Publication
(10) Pub. No.: US 2002/0049279 A1
(43) Pub. Date: Apr. 25, 2002

(54) Solid silicone-based anti-foaming composition, a phytopathological formulation containing it, and preparations thereof

(76) Inventors: Isabelle Gubelmann-Bonneau, Princeton, NJ (US); Jacques Cavezzan, Villeurbanne (FR)

Correspondence Address: RHODIA INC., CN-7500, 259 Prospect Plains Road, CRANBURY, NJ, 08512, US

(21) Appl. No.: 10/007,996

(22) Filed: Nov. 8, 2001

Related U.S. Application Data
(63) Continuation of application No. 09/529,776, filed on Apr. 19, 2000, now abandoned.

(30) Foreign Application Priority Data
Oct. 28, 1997 (FR) 97/13520
Oct. 28, 1998 (FR) PCT/FR98/02312

(51) Int. Cl. C08J 3/00

(52) U.S. Cl. 524/588

(57) ABSTRACT

The invention concerns a composition comprising: at least a silicone substance with defoaming properties in aqueous systems; at least a matrix comprising: at least a porous support; a combination of at least a copolymer with carboxylated groups and at least an alkylaryl sulphonate or an alkylaryl sulphate of an alkaline, alkaline-earth metal or ammonium. The invention also concerns a method for preparing a phytosanitary formulation comprising said composition, which consists in contacting one or several phytosanitary active substances, standard additives and said composition, then grinding, in the presence or not of a solvent, and finally optionally forming the resulting mixture. The invention also concerns phytosanitary formulation containing same.

The present invention relates to a composition comprising a silicone substance with defoaming properties in an aqueous medium, and to solid or liquid phytopathological formulations containing it.

In addition to active ingredients and fillers, phytopathological formulations contain surfactants which, inter alia, improve the wetting and dispersion of formulations during use. However, such surfactants are often the cause of difficulties linked to the production of foam, encountered not only when preparing the formulations but also, and especially, during use.

A number of solutions exist to this problem, but none provide complete satisfaction.

As an example, it is known to add an anti-foaming agent to the phytopathological formulation when it is being applied. The disadvantages of such a solution are that the operator has to use the anti-foaming agent in a tank-mix and that it is not always easy to dose the formulation and the anti-foaming agent correctly.

A further solution has been proposed to prevent excessive foam formation during use before application of wettable powders. French patent FR-A-2 306 635 proposes adding an anti-foaming agent comprising a support on which a silicone is deposited to the phytopathological formulation in powder form. The support, which is inert towards the active ingredient, can be either a mineral powder selected, for example, from talc, kaolin, diatomaceous earth, silica or an organic compound such as starch. Thus the phytopathological formulation is obtained in a number of steps. The first consists of mixing, in general by grinding, the constituent elements such as the active ingredient, fillers, various wetting surfactants and dispersing agents. Then in a second step, the anti-foaming agent cited above is mixed with the formulation previously obtained.

While that solution is more appropriate than the first, it is still a partial solution, since the desired phytopathological formulation necessitates an intermediate dry or wet grinding step. The introduction of this anti-foaming agent after preparing the formulation necessitates the use of a supplemental mixing apparatus. It is not possible to introduce the anti-foaming agent at the stage where the phytopathological formulation proper is being prepared. During the grinding step mentioned above, the anti-foaming agent is destroyed, causing the silicone to leach out. The effectiveness of foam formation control is thus diminished in all cases, or is even non existent if preparation of the formulation requires the addition of water, as is the case with preparations using wet grinding or granulation.

As can be seen, no solid silicone-based anti-foaming agent exists which could be introduced during preparation of the formulation which as a result could resist a wet or a dry grinding step or granulation.

The present invention thus aims to overcome this problem with an anti-foaming composition based on a silicone and a matrix, comprising at least one porous support and a combination of an amphiphilic polymer and an anionic surfactant.

Completely unexpectedly, it has been discovered that the composition of the invention can be introduced into the phytopathological composition when it is being prepared with no loss of effectiveness, even when the preparation necessitates that the constituent elements be ground and/or formed by granulation.

Thus in a first aspect, the invention provides a composition comprising:

at least one silicone substance with defoaming properties in aqueous systems;

at least one matrix comprising:

at least one porous support;

an association of at least one copolymer carrying carboxyl groups and at least one alkali metal, alkaline-earth metal or ammonium alkylaryl sulphonate or alkylaryl sulphate.

In a further aspect, the present invention provides a process for preparing such a composition, consisting of bringing the silicone substance into contact with the matrix and optionally drying the ensemble.

In a still further aspect, the present invention provides a phytopathological formulation comprising the composition of the invention, as an additive having defoaming properties in aqueous systems, in addition to one or more phytopathological active ingredients, and conventional additives.

In a final aspect, the present invention is constituted by a process for preparing such phytopathological formulations, in which the following steps are carried out:

a) one or more phytopathological active ingredients, conventional additives and the solid composition of the invention are brought into contact;

b) grinding is carried out in the presence or absence of a solvent;

c) the resulting mixture is optionally formed.

Further advantages and characteristics of the present invention will become clear from the following description and examples.

As mentioned above, the composition of the invention comprises:

at least one silicone substance with defoaming properties in aqueous systems;

at least one matrix comprising:

at least one porous support;

an association of at least one copolymer carrying carboxyl groups and at least one alkali metal, alkaline-earth metal or ammonium alkylaryl sulphonate or alkylaryl sulphate.

More particularly, the silicone substance (or silicone) is selected from polyorganosiloxanes in which at least 50% of the organic substituents are methyl radicals.

The other radicals in the silicone substance can be hydrogen atoms, hydroxy groups, linear or branched C₁-C₁₀ alkyl radicals, linear or branched C₂-C₁₀ alkenyl radicals, or C₅-C₁₀ aryl or alkylaryl radicals.

More particularly, the silicone substances used have the following formula:

[(R¹)₃SiO]—[R²R⁴SiO]ₓ—[(R³)₂SiO]_{y}—[(R¹)₃SiO]

where:

radicals R¹, which may be identical or different, and substituted or non substituted, represent a linear or branched C₁-C₁₀ alkyl radical; a linear or branched C₂-C₁₀ alkenyl radical; or an aryl, alkylaryl, arylalkyl, aryalkenyl, alkenylaryl radical which is C₅-C₁₀ for the aryl portion and C₁-C₄ for the alkyl or alkenyl portion, or a hydroxy group;

R², R³, R⁴, which may or may not be substituted, and may be identical or different, represent a linear or branched C₁-C₁₀ alkyl radical; a linear or branched C₂-C₁₀ alkenyl radical; or an aryl, alkylaryl, arylalkyl, aryalkenyl, alkenylaryl radical which is C₅-C₁₀ for the aryl portion and C₁-C₄ for the alkyl or alkenyl portion, or a hydroxy group;

x and y represent numbers selected so as to ensure the desired viscosity, in the range 50 to 10⁶ mPa·s..

More particularly, silicone oils are used in which radicals R¹, which may be identical or different, represent methyl, ethyl, vinyl, phenyl or hydroxy radicals. Preferably, radicals R¹ are methyl radicals.

Methyl, ethyl, vinyl or phenyl radicals are preferred for radicals R², R³ and R⁴, it being understood that in a particular embodiment, at least 80% of said radicals are methyl groups.

A preferred example which can be cited is:

(CH₃)₃SiO[(CH₃)₂SiO]_{z}Si(CH₃)₃

where z represents a number sufficient to ensure the viscosity is within the range defined above.

The silicone substance used can be in the form of an oil, an emulsion or a compound.

When the silicone is used in the form of an emulsion, the continuous medium can be selected from water or any other compound which does not or substantially does not dissolve the silicone.

It should be noted that the term “compound” is a conventional term used in the silicone field which defines a silicone substance associated with at least one mineral filler.

More particularly, the viscosity of the compounds is in the range 30 to 60000 mPa·s., using one or more silicone oils.

In general, the specific surface area of the mineral fillers used to obtain the compounds, measured using the BET method, is at least 50 m²/g, in particular in the range 50 to 400 m²/g, preferably more than 70 m²/g. Further, the average particle diameter is less than 0.1 μm, and the apparent density is less than 200 g/l.

More particularly, the mineral filer is selected from silica, ground quartz, calcined clays, or from diatomaceous earth, used alone or as a mixture.

The mineral filler associated with the silicone substance is preferably silica.

This can be in the precipitated or calcined form.

It may have undergone a surface treatment aimed at rendering it hydrophobic. It should be noted that this treatment may already have been carried out or is carried out in situ.

Preferably, when a precipitated silica is used, a treatment rendering it hydrophobic is carried out.

The conventional treatment for rendering the substance hydrophobic consists of bringing the silica into contact with one or more organosiliceous compounds. Compounds of this type which can be cited are methylpolysiloxanes such as hexamethyldisiloxane, octamethylcyclotetrasiloxane; methylpolysilazanes such as hexamethyldisilazane, hexamethylcyclotrisilazane; chlorosilanes such as dimethyldichlorosilane, trimethylchlorosilane, methylvinyldichlorosilane, dimethylvinylchlorosilane; and alkoxysilanes such as dimethylmethoxysilane.

During this treatment, the weight of the silicas may increase by up to 20% of the starting weight.

As is usual in a compound, the proportion of silicone oil with respect to the mineral filler, more particularly with respect to the silica, is in the range 2% to 15%, preferably in the range 2% to 10%.

The compounds are normally prepared by mixing the two components then heating the mixture obtained to between 60° C. and 200° C., in particular to about 150° C., preferably under reduced pressure.

If the treatment rendering it hydrophobic is carried out in situ, the silica undergoes a heat treatment at a temperature of more than 100-150° C., in the absence of the siliceous compounds cited above.

Examples of silicone compounds in the form of an oil, an emulsion or a compound which are commercially available and which can be used in the composition of the invention are Rhodorsil® 47V1000 oil, Rhodorsil® 432 (30% silicone emulsion), Rhodorsil® 471, Rhodorsil® 471LV, Rhodorsil® 454 compounds sold by Rhodia Chimie.

It should be noted that the composition of the invention can comprise one or more silicone substances, used as they are or combined with one or more mineral fillers.

The matrix will now be described.

The first constituent of the matrix is a porous support. Any porous compound which is substantially inert towards the substance is suitable for use in the invention. The term “substantially inert” means that the support substantially does not react with the silicone substance to reduce its anti-foaming and/or defoaming properties.

Further, in its final form, said support can be soluble or insoluble in water.

Non limiting examples of porous supports which can be cited are silica, silicoaluminates, bentonite, zeolites, gypsum, calcium citrate and calcium carbonate.

In a particularly advantageous embodiment of the present invention, the porous support is selected from silicoaluminates or silica. Preferably, the compounds are used in the precipitated form.

In a preferred embodiment of the invention, the composition comprises silica as the support, advantageously precipitated silica.

The matrix used in the composition of the invention also comprises an association of at least one copolymer carrying carboxy groups and at least one alkylaryl sulphonate or an alkylaryl sulphate.

The copolymer carrying the carboxy groups is obtained by polymerisation, preferably radical polymerisation, of at least one linear, branched, cyclic or aromatic ethylenically unsaturated monocarboxylic or polycarboxylic acid or anhydride monomer; and at least one linear or branched aliphatic hydrocarbon monomer containing at least one ethylenic unsaturation.

In an advantageous embodiment of the invention, the acid or anhydride monomer has the following formula:

(R¹)(R¹)—C═C(R¹)—COOH

where radicals R¹, which may be identical or different, represent:

a hydrogen atom;

a hydrocarbon radical, preferably a linear or branched saturated C₁-C₁₀ hydrocarbon radical, optionally comprising a —COOH group;

a —COOH group.

Examples of suitable monomers which can be cited are acrylic, methacrylic, crotonic, maleic, fumaric, citraconic or itaconic acids or anhydrides.

Further, in a particularly advantageous embodiment of the invention, the hydrocarbon monomer has the following formula:

(R²)(R²)—C═CH₂;

where radicals R², which may be identical or different, represent a linear or branched, preferably saturated, C₁-C₃₀ hydrocarbon radical.

Some suitable monomers which can be mentioned are: ethylene, propylene, 1-butene, isobutylene, 1-n-pentene, 2-methyl-1-butene, 1-n-hexene, 2-methyl-1-pentene, 4-methyl-1-pentene, 2-ethyl-1-butene, diisobutylene (or 2,4,4-trimethyl-1-pentene), and 2-methyl-3,3-dimethyl-1-pentene.

Said polymer can also be in the form of an acid, an ester or an alkali metal, alkaline-earth metal or ammonium salt, these forms being present alone or in a combined form. It should be noted that the term “ammonium” means a —NR₃⁺ type radical where R, which may be identical or different, represents hydrogen or a C₁-C₄ alkyl radical.

Preferably the matrix in the above association comprises at least one maleic anhydride/diisobutylene copolymer, in the acid form or in the form of an alkali metal, alkaline-earth metal or ammonium salt, these forms possibly being present alone or in combined form. In a particularly advantageous embodiment, the copolymer is in the form of an alkali metal, alkaline-earth metal or ammonium salt. Preferably, it is in the form of a sodium salt.

More particularly, the ratio of the support, preferably silica or silicoamuminate, to the copolymer in the matrix of the composition of the invention is in the range 2/1 to 4/1 by weight.

Further, the association present in the matrix comprises at least one alkylaryl sulphate or an alkylaryl sulphonate.

In a particular embodiment, the above association comprises at least one alkylaryl sulphonate or an alkylaryl sulphate with a counter-ion selected from alkali metals, alkaline-earth metals or —NR₃⁺ groups where R, which may be identical or different, represents a linear, branched or cyclic alkyl or hydroxyalkyl radical containing 1 to 10 carbon atoms. More particular counter-ions which can be cited are sodium, potassium, ammonium radicals (where R represents hydrogen), diethanolamine, triethanolamine and N-methylcyclohexylamine.

Preferred compounds are alkylbenzene sulphonates in which the linear or branched alkyl portion contains 8 to 15 carbon atoms. It should be noted that the use of alkylnaphthalene sulphonates containing 1 to 3 linear or branched alkyl radicals containing 1 to 4 carbon atoms can be envisaged.

More particularly, the use of dodecylbenzene sulphonate, preferably sodium dodecylbenzene sulphonate, is envisaged.

The alkylaryl sulphates can comprise 1 to 80 oxyalkylenated motifs (oxyethylenated and/or oxypropylenated).

Examples of some compounds which can be used are di- or tri-styrylphenol sulphates, which may be oxyethylenated (3 to 40 motifs).

A particularly advantageous association used in the composition of the matrix is based on a maleic anhydride/diisobutylene copolymer, in the form of a sodium salt, and a sodium dodecylbenzene sulphonate (ratio 90/10). This compound is sold under the trade name Geropon® TA/72 (from Rhodia Chimie).

The weight ratio of the copolymer to the alkylaryl sulphonate and/or alkylaryl sulphate is in the range 1.51 to 10/1.

In a particularly advantageous embodiment, the copolymer and the alkylaryl sulphate and/or alkylaryl sulphonate are associated by drying these two types of compounds together, preferably by spray drying.

In a particular embodiment, the weight ratio of the silicone substance to the matrix in the composition of the present invention is in the range 5/95 to 80/20. Preferably, said weight ratio is in the range 30/70 to 80/20.

The composition of the invention can also comprise at least one partially or completely hydrosoluble compound.

It should be noted that when the solid anti-foaming composition of the invention is added to a phytopathological formulation which does not need to be wet ground in the presence of water, said compound can be at least partially constituted by the porous support of the matrix.

Examples of compounds of this type which can be used in the composition of the invention and which can be cited are saccharides such as glucose, fructose, galactose, arabinose, mannose, dextrose, saccharose, lactose or mixtures thereof.

In a preferred variation, at least one saccharide with a melting point of more than 100° C. is used.

Lactose is a particularly interesting saccharide, in particular D-lactose monohydrate (α form).

At least partially soluble starch, alkali metal, alkaline-earth metal or ammonium phosphates such as tripolyphosphates, dihydrogen phosphates, or alkali metal, alkaline-earth metal or ammonium sulphates are also suitable.

It should be noted that the term “ammonium” means a —NR₃⁺ type radical where R, which may be identical or different, represents hydrogen or a C₁-C₄ alkyl radical such as methyl, ethyl, propyl and its isomers, or butyl and its isomers.

When present, the partially or completely hydrosoluble compound is present in an amount such that the weight ratio of the support, preferably silica or silicoaluminate, of said compound is in the range 1.5/1 to 6/1.

The composition of the invention is obtained by bringing the silicone substance and the matrix into contact, then optionally drying the ensemble.

In a more particular implementation, the silicone substance or substances is/are added to the matrix.

Contact is carried out by any means, such as spraying through a nozzle.

The operation takes place with stirring to homogenise the mixture. As is usual, it is carried out in a Lödige type mixer.

Once brought into contact, the ensemble can be dried if necessary.

Drying is carried out in air, as is usual.

The temperature is advantageously in the range 20° C. to 50° C.

More particularly, and by way of indication, the drying period is in the range from a few minutes to 3 hours.

This operation can readily be carried out in a fixed bed or, as is preferable, in a fluidised bed.

At the end of the process, the composition of the invention is in the form of a powder.

In a variation of the present invention, the composition is in the form of granules.

For such forming, the matrix and silicone substance(s) mixture is granulated once contact has been made.

In a first possibility, the granulation operation can be carried out during contact, if the silicone substance is used in a form including water (for example an emulsion).

If this is not the case, when contact has been made, and preferably after homogenising the matrix/silicone ensemble, the quantity of water required to granulate the mixture is added.

Conventionally, the quantity of water represents 10% to 40% by weight with respect to the weight of the silicone/matrix ensemble.

When granulation is complete, the resulting granules can be dried. The statements made above in this regard remain valid and thus do not need to be repeated here.

The composition of the invention is advantageously used as an agent having defoaming properties in aqueous systems.

More particularly, the composition of the invention can be used as an additive in phytopathological formulations. Advantageously, the composition of the invention can be used in a number of types of phytopathological formulations, the latter being either in the form of a powder or as granules, and also in the form of suspensions.

The present invention thus provides phytopathological formulations comprising the composition described above in detail, as an additive having defoaming properties in aqueous systems, in addition to one or more phytopathological active ingredients and conventional additives.

More particular, the composition of the invention represents in the range 0.1% to 10% by weight with respect to the total formulation weight. The composition preferably represents 0.1% to 5% by weight with respect to the total formulation weight.

The term “phytopathological formulation” means any formulation intended for application in the field of agriculture, comprising at least one biologically active ingredient, in particular a pesticide. Pesticides include herbicides, fungicides, acaricides, insecticides and nematicides.

Examples of suitable active ingredients which can be cited include ametryn, diuron, linuron, chlorotoluon, isoproturon, nicosulfuron, metamitron, primisulfuron-methyl, metsulfuron-methyl, glyphosphate, aclonifen, atrazine, chlorothalonil, cymoxanil, glufosinate, mancozeb, zineb, phenmedipham, the phenoxy family, CMPP, MCPA, 2,4-D, simazine, bromoxynil, active products from the imidazolinone series such as imazapyr, imazaquine, imazethapyr or imazamethabenz.

The amount of active ingredient in the formulation depends on the form of the formulation, either a solid or a suspension.

In the case of wettable powders or dispersible granules, the quantity of active ingredient is generally of the order of 10% to 90% by weight with respect to the total formulation weight.

In the case of concentrated suspensions, the quantity of active ingredient is generally in the range 10% to 70% by weight with respect to the total formulation weight.

In addition to the active ingredients and the composition of the invention, the phytopathological formulations comprise at least one wetting agent.

Non limiting examples of suitable wetting agents which can be cited include N-methyl-N-oleyl taurates, alkyl-diphenylether sulphonate salts, alkylnaphthalene sulphonates, monoalkyl sulphosuccinates and dialkyl sulphosuccinates. These wetting agents can be used alone or as a mixture.

Examples of wetting surfactants which can be cited are Geropon® SDS, Geropon® T/77, Supragil® NC/85, Rhodacal® DS/10 and Supragil® WP, sold by Rhone-Poulenc Chimie.

The quantity of wetting agent can be in the range 0.5% to 10% by weight with respect to the total formulation weight, preferably in the range 1% to 5% by weight with respect to the total formulation weight.

The phytopathological formulations of the present invention can also comprise at least one dispersing agent.

Suitable dispersing agents for use in the present invention which can be mentioned include alkali metal or ammonium salts of polycarboxylates such as polyacrylates; alkali metal or ammonium salts of alkylnaphthalene sulphonates condensed with formol; alkali metal or ammonium salts of 4,4′-dihydroxybiphenylsulphonate condensed with formol; alkali metal or ammonium salts of alkylarylphosphates or alkylarylsulphates such as phosphates or sulphated mono-, di- or tri-styrylphenols which may or may not be neutralised; alkali metal or ammonium salts of lignosulphonates, and mixtures thereof. It should be noted that the term “ammonium” has the same meaning as that given above.

Non limiting illustrations of dispersing agents include: Geropon® T/36, Geropon® TA/72, Geropon® SC/213, Supragil® MNS/90, Supragil® GN, Soprophor FL, Soprophor FLK and Soprophor® 4D384.

The quantity of dispersing agent in the formulation is generally in the range 2% to 20% by weight with respect to the total formulation weight, preferably in the range 2% to 15% by weight with respect to the total formulation weight. It is advantageously in the range 2% to 10% by weight, with respect to the total formulation weight.

The formulations of the present invention can also comprise at least one filler which is inert towards the other constituents of the formulation and more particularly towards the active ingredient.

The inert filler can be soluble or insoluble in water, depending on whether the phytopathological formulation into which it is incorporated necessitates wet grinding or otherwise.

Non limiting examples of inert fillers which can be used in the phytopathological formulations of the invention which can be cited include soluble or partially soluble starch, bentonite, kaolin, diatomaceous earth, attapulgite, zeolites, calcium carbonate, talc, mica, silica, silico-aluminates, and alkali metal, alkaline-earth metal or ammonium sulphates.

The formulations of the invention can comprise between 1% to 15% by weight of inert filler with respect to the total formulation weight.

A process for preparing the formulation of the invention will now be described.

The process consists of carrying out the following steps:

a) bringing one or more phytopathological active ingredients, conventional additives and the solid composition of the invention into contact;

b) grinding in the presence or absence of a solvent;

c) optionally, forming the resulting mixture.

Step a) is carried out in a manner which is conventional in the industry. The various constituent elements are mixed in a suitable apparatus.

Step b) can be carried out in the presence or absence of a solvent.

When in the absence of a solvent (dry grinding), a hammer mill or an air jet mill is used, as is conventional.

It should be noted that the term “dry grinding” means grinding separated particles which can however comprise a certain amount of moisture. This degree of moisture is usually in the range 0 to 5% by weight with respect to the total formulation weight.

The operation is generally carried out in air.

The duration is such that a homogeneous product is obtained with a granulometry in the 5% range 1 to 100 μm.

When in the presence of a solvent (wet grinding), the solvent is advantageously water; however, other products such as vegetable oils, mineral oils or fatty acid esters can be used.

The amount of solvent is such that a suspension (slurry) can be ground. The quantity of solvent is usually in the range 20% to 70% by weight with respect to the total formulation weight.

The operation is generally carried out in air.

The duration is such that a homogeneous product is obtained with a granulometry in the range 1 to 15 μm.

At the end of grinding step b), the resulting product can optionally be formed.

In the case of dry grinding, two variations are possible.

In a first variation, the final product corresponds to the product obtained after grinding step b). The product is then in the form of a powder and can be used as it is in a manner which is conventional in this industry.

In the second possible variation, the powder from the dry grinding step described above is granulated.

The granulation operation is an operation which is routine in the industry.

It is carried out by adding a solvent in a quantity which is normally in the range 5% to 50% by weight with respect to the weight of the product obtained at the end of the grinding step, preferably 5% to 20% by weight with respect to the weight of the product obtained at the end of the grinding step.

The granulation operation can be carried out in any suitable granulating apparatus which is well known to the skilled person. However, this step is preferably carried out using a Lödige type granulator.

A supplemental forming step, for example extrusion, can then be carried out.

It should be noted that this granulation step is not obligatory, although it is preferred.

Once the formulation has been formed, the resulting product is preferably dried.

Drying is advantageously carried out in air.

The operation can be carried out in a fixed, fluidised or transported bed.

The temperature is selected as a function of a number of criteria such as the stability of the active ingredient, that of the anti-foaming composition of the invention, or the nature of the solvent used during granulation. This temperature is conventionally in the range 20° C. to 80° C.

The drying period is such that a moisture content of 0 to 3% is obtained.

In this variation, a formulation is obtained in the form of granules which may be extruded.

When carrying out wet grinding, here again two variations are possible.

The first variation consists of using the product in the form of the suspension obtained after the grinding step.

The second variation, in the case where grinding has been carried out in the presence of a solvent, consists of drying the resulting suspension.

Drying can be carried out using conventional means. Preferably, however, drying is carried out by spray drying, i.e., by spraying the suspension into a hot atmosphere. Spray drying can be carried out using any known spray apparatus, for example a rose type or other type of spray nozzle. It is also possible to use turbine spray dryers. Regarding the various spraying techniques which can be employed in the present invention, reference should be made to the standard text by MASTERS entitled “SPRAY-DRYING” (second edition, 1976, George Godwin—London).

The spray drying operation can also be carried out using a “flash” reactor, for example that described in French patent applications FR-A-2 257 326, FR-A-2 419 754 and FR-A-2 431 321.

The drying temperature is lower than the temperature at which the active ingredient degrades. As an example, the drying temperature is in the range 90° C. to 300° C.

A phytopathological formulation is obtained in the form of a powder.

The formulation of the invention, in any of its forms, has the advantage of being readily dispersible when mixed with water before use, and does not cause excessive foam formation when mixing with water.

Non limiting examples of the invention will now be given.

### EXAMPLE 1

In this example the composition of the invention was prepared.

Firstly, the following mixture of powders was prepared:

| Silica | 60% (by weight) |
|---|---|
| Lactose | 20% |
| Geropon ® TA/72 | 20% |

The mixture obtained was brought into contact with a Rhodorsil® 454 silicone anti-foaming agent in proportion of 50/50 by weight. The mixing operation was carried out in a Lödige apparatus.

### EXAMPLE 2

In this example, a phytopathological composition based on Atrazine comprising the composition obtained in Example 1 was prepared.

The following composition was prepared:

| Atrazine | 89% (by weight) |
|---|---|
| Igepal ® BC 10 | 2% |
| Geropon ® TA/72 | 8% |
| Composition from Example 1 | 1% |

Igepal: ethoxylated nonylphenol (10 OE).

The powders were mixed in an air jet mill, then water was added in a quantity sufficient to obtain a paste which was extruded in a Basket extruder (Fuji Paudal). The resulting granules were then dried in a fluidised bed (60° C.). The height of the composition foam, on preparation and after being treated for 15 days at 54° C., was then measured using the following test:

100 ml of water (500 ppm) was poured into a 100 ml flask;

2 g of granules to be tested were weighed out and placed into the flask.

the flask was stoppered.

The flask was upturned and turned upright again 30 times, allowing the air bubble to rise into the upper portion at each turn.

the flask was unstoppered.

the foam volume was measured at 0, 1, 5, 10, 20 and 30 minutes.

The results are shown in the following table:

| Foam volume | | | | |
|---|---|---|---|---|
| (ml) | Initial | | After 15 days at 54° C. | |
| Time (min) | Invention | Blank(*) | Invention | Blank(*) |
| 0 | 21.4 | 27.5 | 20.8 | 19.7 |
| 1 | 19.7 | 24.7 | 19.1 | 19.1 |
| 5 | 19.1 | 24.2 | 18.5 | 19.1 |
| 10 | 19.1 | 23.6 | 18.0 | 18.5 |
| 20 | 18.5 | 23.6 | 16.9 | 17.4 |
| 30 | 11.2 | 21.4 | 15.2 | 17.4 |

(*) The tests were carried out in the absence of the composition of the invention.

It can be seen that the phytopathological formulation comprising the composition of the invention preserved its low foaming properties.

### EXAMPLE 3

In this example, a phytopathological composition based on ametryn comprising the composition obtained in Example 1 was prepared.

| Ametryn | 87% (by weight) |
|---|---|
| Supragil ® NK | 4% |
| Geropon ® TA/72 | 8% |
| Composition of Example 1 | 1% |

Supragil: alkylnaphthalene sulphonate.

The formulation was obtained using the same method as that used to obtain the formulation of Example 2.

The foam height of the composition was measured on preparation and after treating for 1 month at 54° C. using the test described in Example 2.

The results are shown in the following table:

| Foam volume (ml) | | |
|---|---|---|
| Time (min) | Initial | After 1 month at 54° C. |
| 0 | 21.3 | 20.2 |
| 1 | 15.2 | 12.9 |
| 5 | 9.5 | 8.4 |
| 10 | 7.8 | 7.8 |
| 20 | 7.3 | 6.7 |
| 30 | 5.6 | 5.6 |

1. A composition comprising:
at least one silicone substance with anti-foaming properties in aqueous systems;
at least one matrix comprising:
at least one porous support;
an association of at least one copolymer carrying carboxyl groups and at least one alkali metal, alkaline-earth metal or ammonium alkylaryl sulphonate or alkylaryl sulphate.

2. A composition according to the preceding claim, characterized in that the silicone substance is selected from polyorganosiloxanes in which at least 50% of the organic substituents are methyl radicals.

3. A composition according to any one of the preceding claims, characterized in that the silicone substance is in the form of an oil, an emulsion or a compound.

4. A composition according to the preceding claim, characterized in that the silicone substance is in the form of a compound wherein the mineral filler associated with the silicone substance is selected from a precipitated silica and a calcined silica, optionally having undergone a surface treatment to render it hydrophobic.

5. A composition according to claim 3 or claim 4, characterized in that the proportion of silicone oil with respect to the mineral filler in the compound is in the range 2 to 15, preferably in the range 2 to 10.

6. A composition according to any one of claims 1 to 5, characterized in that the porous support of the matrix is selected from silicoaluminates, silica, bentonite, zeolites, gypsum, calcium citrate and calcium carbonate.

7. A composition according to any one of claims 1 to 6, characterized in that the association cited above comprises, as the copolymer carrying carboxy groups, at least one copolymer obtained by polymerisation of at least one linear, branched, cyclic or aromatic and ethylenically unsaturated monocarboxylic or polycarboxylic acid or anhydride monomer; and at least one linear or branched aliphatic hydrocarbon monomer carrying at least one ethylenic unsaturation.

8. A composition according to the preceding claim, characterized in that the acid or anhydride monomer has the following formula:
(R¹)(R¹)—C═C(R¹)—COOH
where radicals R¹, which may be identical or different, represent:
a hydrogen atom;
a hydrocarbon radical, preferably linear or branched saturated C₁-C₁₀, optionally comprising a —COOH group;
a —COOH group.

9. A composition according to claim 7 or claim 8, characterized in that the acid or anhydride monomer is selected from acrylic, methacrylic, crotonic, maleic, fumaric, citraconic or itaconic acids or anhydrides.

10. A composition according to claim 7, characterized in that the hydrocarbon monomer has the following formula:
(R¹)(R²)—C═CH₂;
where radicals R², which may be identical or different, represent a linear or branched, preferably saturated, C₁-C₃₀ hydrocarbon radical.

11. A composition according to the preceding claim, characterized in that the hydrocarbon monomer is selected from ethylene, propylene, 1-butene, isobutylene, 1-n-pentene, 2-methyl-1-butene, 1-n-hexene, 2-methyl-1-pentene, 4-methyl-1-pentene, 2-ethyl-1-butene, diisobutylene (or 2,4,4-trimethyl-1-pentene), and 2-methyl-3,3-dimethyl-1-pentene.

12. A composition according to any one of the preceding claims, characterized in that the copolymer carrying carboxy groups is in the acid form, ester form or alkali metal, alkaline-earth metal or ammonium salt form, these forms possibly being present alone or in combination.

13. A composition according to any one of the preceding claims, characterized in that the copolymer carrying carboxy groups is a maleic anhydride/diisobutylene copolymer, in the acid form, or in the form of an alkali metal, alkaline-earth metal or ammonium salt, these forms possibly being present alone or in combination.

14. A composition according to the preceding claim, characterized in that the compound is in the form of a sodium salt.

15. A composition according to any one of the preceding claims, characterized in that the weight ratio of the support to the copolymer in the matrix is in the range 2/1 to 4/1.

16. A composition according to any one of the preceding claims, characterized in that the association present in the matrix comprises at least one alkylaryl sulphonate or an alkylaryl sulphate with a counter-ion selected from alkali metal, alkaline-earth metal or —NR₃⁺ groups where R, which may be identical or different, represents a linear, branched or cyclic hydrocarbon radical containing 1 to 10 carbon atoms.

17. A composition according to the preceding claim, characterized in that the association cited above comprises at least one alkali metal, alkaline-earth metal or ammonium alkylaryl sulphonate, more particularly dodecylbenzene sulphonate.

18. A composition according to any one of the preceding claims, characterized in that the weight ratio of the copolymer to the alkylaryl sulphate and/or alkylaryl sulphonate is in the range 1.5/1 to 10/1.

19. A composition according to any one of the preceding claims, characterized in that the association present in the matrix is obtained by drying the copolymer and the alkylaryl sulphate and/or alkylaryl sulphonate together, preferably by spray drying.

20. A composition according to any one of the preceding claims, characterized in that the weight ratio of the silicone substance to the matrix defined above is in the range 5/95 to 80/20, preferably in the range 30/70 to 80/20.

21. A composition according to any one of the preceding claims, characterized in that it further comprises at least one partially or completely hydrosoluble compound.

22. A composition according to the preceding claim, characterized in that the compound defined above is selected from saccharides, at least partially soluble starch, alkali metal, alkaline-earth metal or ammonium phosphates such as tripolyphosphates or dihydrogen phosphates, or alkali metal, alkaline-earth metal or ammonium sulphates.

23. A composition according to claim 21 or 22, characterized in that the weight ratio of the support to the compound defined above is in the range 1.5/1 to 6/1.

24. A process for preparing a composition according to any one of claims 1 to 23, characterized in that the silicone substance and the matrix are brought into contact, then the ensemble is optionally dried.

25. Use of the composition according to any one of claims 1 to 23, or obtainable in accordance with claim 24, as an agent with defoaming properties in aqueous systems.

26. Use according to the preceding claim, as an additive in phytopathological formulations.

27. A phytopathological formulation comprising the composition according to any one of claims 1 to 23, as an additive with defoaming properties in aqueous systems, in addition to one or more phytopathological active ingredients, and to conventional additives.

28. A formulation according to the preceding claim, characterized in that it comprises in the range 0.1% to 10% by weight of the composition defined above, with respect to the total formulation weight, preferably in the range 0.1% to 5% by weight with respect to the total formulation weight.

29. A formulation according to claim 27 or claim 28, characterized in that the active phytopathological material is selected from pesticides.

30. A formulation according to any one of claims 27 to 29, characterized in that it comprises at least one wetting agent.

31. A formulation according to the preceding claim, characterized in that the wetting agent is selected from N-methyl-N-oleyl taurates, alkyl-diphenylether sulphonate salts, alkylnaphthalene sulphonates, monoalkyl sulphosuccinates and dialkyl sulphosuccinates; these wetting agents being used alone or as a mixture.

32. A formulation according to claim 30 or claim 31, characterized in that the quantity of wetting agent is in the range 0.5% to 10% by weight with respect to the total formulation weight, preferably in the range 1% to 5% by weight with respect to the total formulation weight.

33. A formulation according to any one of claims 27 to 32, characterized in that it further comprises at least one dispersing agent.

34. A formulation according to the preceding claim, characterized in that the dispersing agent is selected from alkali metal or ammonium salts of polycarboxylates; alkali metal or ammonium salts of alkylnaphthalene sulphonates condensed with formol; alkali metal or ammonium salts of 4,4′-dihydroxybiphenylsulphonate condensed with formol; alkali metal or ammonium salts of alkylarylphosphates or alkylarylsulphates; alkali metal or ammonium salts of lignosulphonates, and mixtures thereof.

35. A formulation according to claim 33 or claim 34, characterized in that the quantity of dispersing agent is in the range 2% to 20% by weight with respect to the total formulation weight, preferably in the range 2% to 15% by weight with respect to the total formulation weight.

36. A formulation according to any one of claims 27 to 35, characterized in that it comprises at least one inert filler.

37. A formulation according to the preceding claim, characterized in that the inert filler is selected from soluble or partially soluble starch, bentonite, kaolin, diatomaceous earth, attapulgite, zeolites, calcium carbonate, talc, mica, silica, silico-aluminates and alkali metal, alkaline-earth metal or ammonium sulphates.

38. A formulation according to claim 36 or claim 37, characterized in that the amount of inert filler is in the range 1% to 1 5% by weight with respect to the total formulation weight.

39. A process for preparing a phytopathological formulation according to any one of claims 27 to 38, in which the following steps are carried out:
a) one or more phytopathological active ingredients, conventional additives and the composition of the invention are brought into contact;
b) grinding is carried out in the presence or absence of a solvent;
c) the resulting mixture is optionally formed.
